(19) United States
(12) Patent Application Publication
(10) Pub. No.: US 2019/0072186 A1
(43) Pub. Date: Mar. 7, 2019

(54) SEAL ASSEMBLY FOR A ROTARY MACHINE

(71) Applicant: General Electric Company, Schenectady, NY (US)

(72) Inventors: Rahul Anil Bidkar, Niskayuna, NY (US); Bugra Ertas, Niskayuna, NY (US); Christopher Wolfe, Niskayuna, NY (US); Deepak Trivedi, Niskayuna, NY (US)

(21) Appl. No.: 15/697,062

(22) Filed: Sep. 6, 2017

(51) Int. Cl. F16J 15/447

(52) U.S. Cl. CPC F16J 15/4476; F01D 11/04

(57) ABSTRACT

A seal assembly for a rotary machine includes plural seal segments disposed circumferentially intermediate to a stationary housing and a rotor. One or more of the seal segments includes a stator interface element, a radially oriented front cover plate, and a movably supported shoe plate. The shoe plate includes one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid through the shoe plate or through the front cover plate, and between the radial surface of the shoe plate and the front cover plate to form the frictionless secondary seal.

### GOVERNMENT LICENSE RIGHTS

This invention was made with government support under contract number DE-FE0024007 awarded by the U.S. Department Of Energy. The government has certain rights in the invention.

### FIELD

The subject matter described herein relates to seal assemblies in rotary machines.

### BACKGROUND

Many rotary machines, such as gas turbines, steam turbines, aircraft engines, supercritical CO2 turbines, compressors and other rotary machines, have seals between the moving components (e.g., rotors) and the stationary components (e.g., stators). These seals help to reduce leakage of fluids between the rotors and stators. Increased leakage between rotors and stators can significantly reduce the power generated by the rotary machines; thereby lowering the operating efficiency of the rotary machines.

Typically, labyrinth seals are used for reducing the leakage through circumferential rotor-stator gaps. The radial clearance between rotors and stators can change up to 6.35 millimeters on account of thermal transients and centrifugal growth. Labyrinth seals that are assembled with small radial clearances result in seal rubs (which have increased wear and degraded leakage performance), whereas labyrinth seals assembled having large radial clearances to avoid seals rubs lead to increased leakage. These seals are not able to maintain small clearances during steady-state operation and are not able to radially move with the rotor during a rotor transient so that any rubbing between the seal and the rotor is avoided.

### BRIEF DESCRIPTION

In one embodiment, a seal assembly for a rotary machine includes plural seal segments disposed circumferentially intermediate to a stationary housing and a rotor. One or more of the seal segments includes a stator interface element, a radially oriented front cover plate, and a movably supported shoe plate. The shoe plate includes one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid through the shoe plate or through the front cover plate, and between the radial surface of the shoe plate and the front cover plate to form the frictionless secondary seal.

In one embodiment, a method includes forming one or more seal segments of a seal assembly for a rotary machine using additive manufacturing. The one or more seal segments are shaped to be positioned circumferentially intermediate to a stationary housing and a rotor of the rotary machine. Forming the one or more of the seal segments includes forming a stator interface element, a radially oriented front cover plate, and a shoe plate using additive manufacturing. The shoe plate is formed using additive manufacturing to include one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid from outside of the shoe plate, through the shoe plate, and between the radial surface of the shoe plate and the front cover plate to form the frictionless secondary seal.

In one embodiment, an assembly includes plural seal segments shaped to be disposed circumferentially between a stator and a rotor of a rotary machine. At least one of the seal segments includes a stator interface plate positioned to face the stator, a front cover plate in contact with the stator interface plate and positioned to radially extend between the stator and the rotor, and a shoe plate having a radial face that opposes the front cover plate and a bearing surface positioned to face the rotor. The shoe plate and/or the front plate has one or more internal passages shaped to direct fluid from outside of the at least one seal element to a gap in a seal between the radial face of the shoe plate and the front cover plate. The one or more internal passages are shaped to direct the fluid to the gap to reduce or eliminate friction between the radial face of the shoe plate and the front cover plate.

### BRIEF DESCRIPTION OF THE DRAWINGS

The present inventive subject matter will be better understood from reading the following description of non-limiting embodiments, with reference to the attached drawings, wherein below:

FIG. 1 illustrates a front perspective view of a seal assembly in conjunction with part of a rotary machine;

FIG. 2 illustrates a rear perspective view of the seal assembly shown in FIG. 1;

FIG. 3 illustrates a front perspective view of one seal segment in the seal assembly according to one embodiment;

FIG. 4 illustrates a rear perspective view of the seal segment shown in FIG. 3;

FIG. 5 illustrates a perspective view of a seal segment according to another embodiment;

FIG. 6 illustrates a cross-sectional view of the seal segment shown in FIG. 5 according to one embodiment;

FIG. 7 illustrates plural seal segments shown in FIG. 5 coupled with each other and engaged with the rotor shown in FIG. 1 according to one embodiment;

FIG. 8 illustrates a perspective view of another embodiment of a seal segment;

FIG. 9 illustrates a cross-sectional view of the seal segment shown in FIG. 3 according to one embodiment;

FIG. 10 illustrates another embodiment of the seal segment shown in FIG. 3 that includes a spline seal;

FIG. 11 illustrates a cross-sectional view and magnified view of the seal segment shown in FIG. 3 to demonstrate operation of a self-adjusting secondary-seal shown in FIG. 3 according to one example;

FIG. 12 illustrates a cross-sectional view of a shoe plate of the seal segment shown in FIG. 3 to demonstrate operation of a self-adjusting secondary-seal shown in FIG. 3 according to one example;

FIG. 13 illustrates another cross-sectional view and magnified view of the seal segment shown in FIG. 3 to demonstrate operation of a self-adjusting secondary-seal shown in FIG. 3 according to one example;

FIG. 14 illustrates another cross-sectional view of a shoe plate of the seal segment shown in FIG. 3 to demonstrate operation of a self-adjusting secondary-seal shown in FIG. 3 according to one example;

FIG. 15 illustrates a front perspective view of the seal segment shown in FIG. 3 with a front cover plate shown in FIG. 1 removed according to one example;

FIG. 16 illustrates a cross-sectional view of another embodiment of the seal segment shown in FIG. 1;

FIG. 17 illustrates a cross-sectional view of the seal segment shown in FIG. 15 along a cross-sectional plane shown in FIG. 15;

FIG. 18 illustrates a relationship between a thickness of a secondary seal fluid film formed in a gap between the front cover plate shown in FIG. 1 and the shoe plate shown in FIG. 2, and a force exerted on a face of the shoe plate shown in FIG. 9 according to one example; and

FIG. 19 illustrates a cross-sectional view of the seal segment shown in FIG. 1 with counterbores around aerostatic ports shown in FIG. 14 according to one embodiment.

### DETAILED DESCRIPTION

One or more embodiments of the inventive subject matter described herein provide seal assemblies for rotary machines. The seal assemblies are film-riding hybrid aerostatic-aerodynamic seals for sealing rotor-stator circumferential gaps in gas turbines, steam turbines, aircraft engines, supercritical CO2 turbines, centrifugal compressors, and other rotary machinery. As used herein, the terms “aerostatic” and “aerodynamic” are used to refer to the types of load-bearing pressures in a fluid film formed between the seal assembly and a rotor. The aerostatic forces are fluid film forces created due to pressurization and are thus pressure-dependent in nature. The aerodynamic forces are forces in the fluid film that are dependent on the speed at which the rotor rotates. The term “aero” or fluid should not restrict all embodiments of the inventive subject matter described herein to air as the working fluid. The seal assemblies can operate with other working fluids such as nitrogen, hydrogen, supercritical and gaseous CO2, and steam.

In one embodiment, a seal includes an assembly of several segments forming a 360-degree assembly to reduce the rotor-stator leakage. Each segment of this seal includes springs, a frictionless (or reduced friction) secondary seal formed by the interface between a front cover plate and individual segments, a shoe, and a stator interface element for attaching the spring and shoe to a turbomachinery stator. Optionally, each segment can be attached individually to the stator of the rotary machinery or several segments can be attached simultaneously to a single stationary piece of the rotary machinery

In another embodiment, a seal includes an assembly of several segments forming a 360-degree assembly to reduce rotor-stator leakage. Each segment of this seal can include a shoe, a frictionless (or reduced friction) secondary seal formed by the interface between a front cover plate and individual segments, and a garter spring for supporting one or more, or all, individual shoes against the rotor.

The assembly reduces the flow of the fluid (e.g. air) through the circumferential rotor-stator gap relative to other types of seals. This seal also acts like a movable spring-shoe under the influence of aerostatic and aerodynamic loads.

Each segment maintains an air film between the shoe and the rotor, thereby ensuring that there is no contact (e.g., rubbing) between the shoe and the rotor. Furthermore, after pressurization, each shoe maintains an air film between the shoe and the front cover plate, thereby ensuring negligible friction force in the radial direction. These seals are based on the foil bearing and hybrid bearing technology.

The seal assemblies improve predictability for aerostatic force balance and radial operation of the seal assemblies, and eliminate or significantly reduce the radial friction force from the secondary seal, thereby allowing for predictable radial motion of the seal assemblies. The seal assemblies can operate with both aerostatic and aerodynamic modes of operation, which increases load-bearing capacity of the assemblies. Ports and feeding grooves of the assemblies control pressure distributions on the shoes and control cooling flow around the shoes. In one embodiment, the seal assemblies have spline seals between neighboring shoes to reduce leakage between neighboring seal segments. In other embodiments, neighboring shoes are interlocked with one another (without restricting radial motion of shoes) to reduce leakage between neighboring seal segments. Load-bearing surfaces of the seal assemblies can have patterns of aerostatic feedholes and counterbores that allow for tilt correction and moment-bearing capacity of the seal assemblies.

Shoes of the seal assemblies can have either a curvature mismatch with the rotor and/or one or more grooves, steps, pockets, or the like that generate additional radial force in an aerodynamic operation mode. There optionally can be grooves, steps, pockets, or the like on the rotor to generate aerodynamic force. The rotor can be a stepped rotor to provide for reliable operation of the seal assemblies.

These seal assemblies described herein can provide advantages over other existing labyrinth sealing technologies. One or more embodiments of the seal assemblies are relatively very cheap to fabricate and present a reliable, robust seal for several locations in rotary machinery with high pressure drops and large transients. The non-contact operation of these seal assemblies makes the assemblies especially useful for large rotor transient locations where, due to limitations of the current labyrinth seal technology, large steady-state clearances typically are used (which thereby cause or result in significant leakage) to avoid rubs and wear.

The aerostatic feature of the seal assemblies improves load-bearing capacity and allows operation of the seal assemblies at increased running gaps compared to previous foil seals. This increased gap enables seal operation at higher speeds. Furthermore, the frictionless secondary seal allows for high differential pressure operation, which is not possible with previous secondary seal concepts. Specifically, in previous radial seal designs, the secondary seal friction force scales with the differential pressure and makes the seal inoperable for large differential pressures. The concept of the inventive subject matter described herein reduces or eliminates the large pressure-dependent frictional force, thereby enabling the seal for large differential pressure operation.

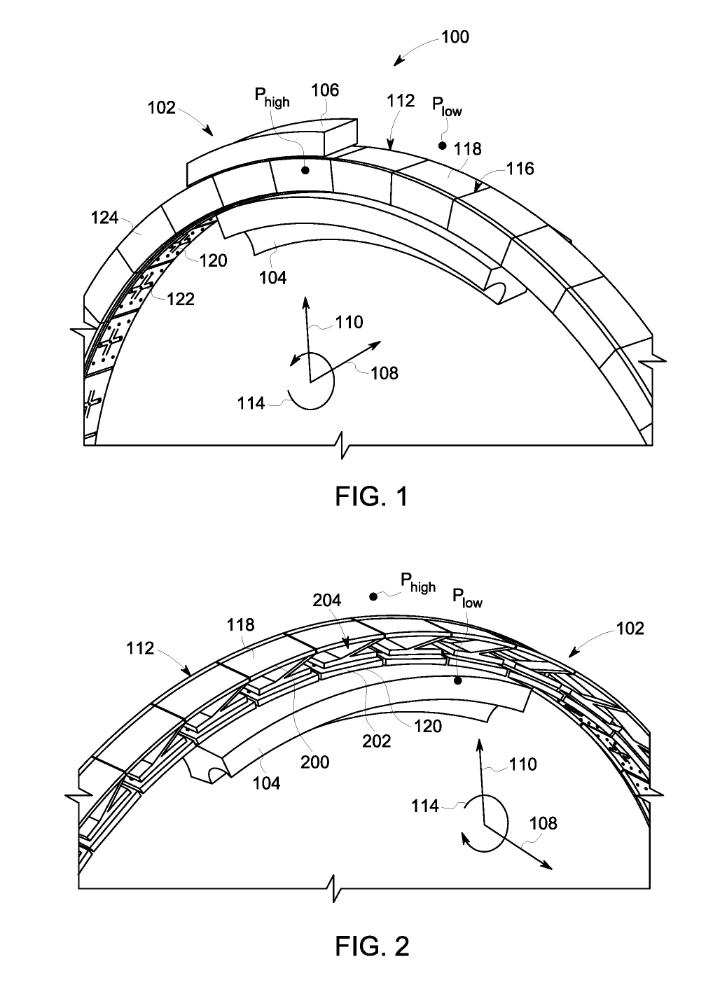

FIG. 1 illustrates a front perspective view of a seal assembly 100 in conjunction with part of a rotary machine 102. The rotary machine 102 includes a moveable (e.g., rotating) stepped rotor 104 and a stationary housing, or stator, 106. The rotor 104 rotates relative to the stator 106 and the seal assembly 100 by rotating around or about an axis of rotation 108 (that coincides with or extends parallel to an axial direction 108 of the rotary machine 102).

The seal assembly 100 is formed by assembling several seal segments 112 circumferentially around the axis of rotation 108 along a circumferential direction 114 and between the rotor 104 and stator 106. The seal assembly 100 is used to reduce or minimize (e.g., eliminate) the leakage of fluid (e.g., working fluid, exhaust or other gases) between a cavity that is upstream of the rotor 104 and seal assembly 100 (e.g., along the axial direction 108 shown in FIG. 1) and a cavity that is downstream of the rotor 104 and seal assembly 100 in the rotary machine 102 (e.g., along the axial direction 108 shown in FIG. 1).

Higher pressure fluid (shown as P_{high} in the Figures) in the upstream cavity passes through and rotates the rotor 104 along the axial direction 108 to the downstream cavity as lower pressure fluid (shown as P_{low} in the Figures) along the axial direction 108 shown in FIG. 1. Front cover plates 124 of the seal segments 112 face the high-pressure fluid in the upstream cavity. The front cover plates 124 are radially oriented in that the plates 124 radially extend between the stator 106 and rotor 104 (e.g., extend along radial directions 110). Opposite rear surfaces of the seal segments 112 (not visible in FIG. 1) face the low-pressure fluid in the downstream cavity.

The neighboring seal segments 112 are separated by a small intersegment gap 116 that allows for free motion of the individual seal segments 112 relative to each other (predominantly in the radial direction 110) of each segment 112, which is unaffected by the neighboring seal segments 112. Each seal segment 112 includes a stator interface surface or plate 118 that faces and/or directly engages the stator 106 and an opposite load-bearing surface 120 that faces the rotor 104. The stator interface surfaces 118 can be used for attaching (e.g., by bolting, brazing, or welding) each seal segment 112 to the stator 106. The load-bearing surfaces 120 are parts of shoes of the seal segments 112, as described herein. These shoes optionally can include spline seals that reduce or eliminate fluid leakage between the neighboring seal segments 112 in one embodiment.

The load-bearing surfaces 120 can include hydrostatic ports 122 through which at least some of the fluid passing through internal passages in the seal segments 112 flows. As described herein, these ports 122 direct this fluid between the seal segments 112 and the rotor 104 to allow the seal segments 112 (and the seal assembly 100) to float above the rotor 104 (to avoid wearing down the seal segments 112) while maintaining a seal between the seal assembly 100 and the rotor 104 that prevents or reduces passage of the high-pressure fluid between the seal assembly 100 and the rotor 104 to the downstream cavity.

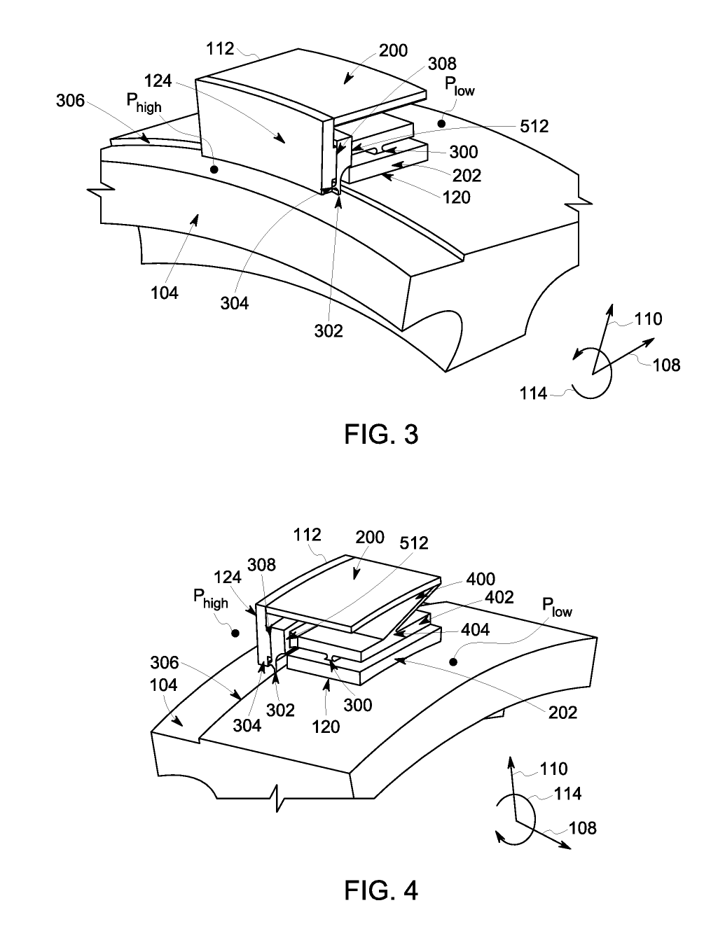

FIG. 2 illustrates a rear perspective view of the seal assembly 100 shown in FIG. 1. FIG. 3 illustrates a front perspective view of one seal segment 112 in the seal assembly 100 according to one embodiment. FIG. 4 illustrates a rear perspective view of the seal segment 112 shown in FIG. 3. The stator 106 is not shown in FIGS. 2 through 4.

The seal segments 112 include stator interface elements 200, which are curved, thin bodies that include the stator interface surfaces 118. The seal segments 112 also include shoe plates 202 that are opposite of the stator interface elements 200. The shoe plates 202 include the load-bearing surfaces 120. The shoe plates 202 in neighboring seal segments 112 may be interlocked with each other by slanted faces or surfaces that reduce leakage of fluid between the neighboring shoe plates 202.

The shoe plates 202 and stator interface elements 200 are coupled with each other by flexible elements 204. The flexible element 204 is shown as an angled planar or substantially planar body 400 and a curved thin body 402 (shown in FIG. 4) joined at an acute angle with respect to each other. The angled body 400 of the flexible element 204 extends from the stator interface element 200 toward the curved body 402. The angled body 400 is oriented at a transverse or acute angle to each of the thin body 402 and the stator interface element 200 in the illustrated embodiment. Optionally, the flexible elements 204 can be springs, flexures, bellow springs, or the like.

The flexible elements 204 moveably support the shoe plates 202 with the stator interface elements 200 in that the flexible elements 204 can flex to permit the shoe plates 202 to move relative to the stator interface elements 200 as the radial distance between the stator 106 and rotor 104 changes during operation of the rotary machine 102. This can prevent the shoe plates 202 from contacting and rubbing against the rotor 104, which wears down and damages the seal segments 112. For example, the flexible elements 204 can provide radial compliance, rotational rigidity about the circumferential and axial directions 114, 108, and guide the motion of the shoe plates 202 (e.g., along the radial and axial directions 110, 108).

In the illustrated embodiment, the flexible element 204 includes a rolling flexural pivot 404 (shown in FIG. 4) at the connection or intersection between the bodies 400, 402 of the flexible element 204. The rolling flexural pivot 404 can be elongated and axially extend along the axial direction 108 or parallel to the axial direction 108. The rolling flexural pivot 404 allows for rotational motion (e.g., rolling) of the stator interface element 200, the flexible element 204, and/or the front cover plate 124 (e.g., by virtue of the cover plate 124 being coupled with the flexible element 204). This rotational motion includes the rolling of one or more of these components in directions about or around the axial direction 108. This degree of freedom is useful for the film-riding shoe plate 202 to form a converging-diverging fluid film wedge between the rotor 104 and the shoe plate 202. As described below, the shoe plate 202 floats or rides above the rotor 104 by forming a fluid film between the load-bearing surface 120 and the rotor 104. The rotational motion of components of the seal segment 112 allowed by the rolling flexural pivot 404 can ensure that the converging-diverging fluid film wedge shape is maintained and that a separation gap between the shoe plate 202 and the rotor 104 even when the gaps between the shoe plate 202 and rotor 104 change during operation of the rotary machine 102.

The shoe plate 202 optionally includes a pitching flexural pivot 300 (shown in FIG. 3) to allow for pitching degree of freedom of the seal segment 112. The pitching flexural pivot 300 is formed by a protrusion that juts out from the lower surface of the curved body 402 of the flexible element 204 in a direction that is opposite the radial direction 110 and that is toward the axis of rotation 108. The pitching flexural pivot 300 can be elongated and circumferentially extend along the circumferential direction 114 or parallel to the circumferential direction 114. The pitching degree of freedom allows the shoe plate 202 to adjust (e.g., move) to front-aft tilting or coning motion of the rotor 104.

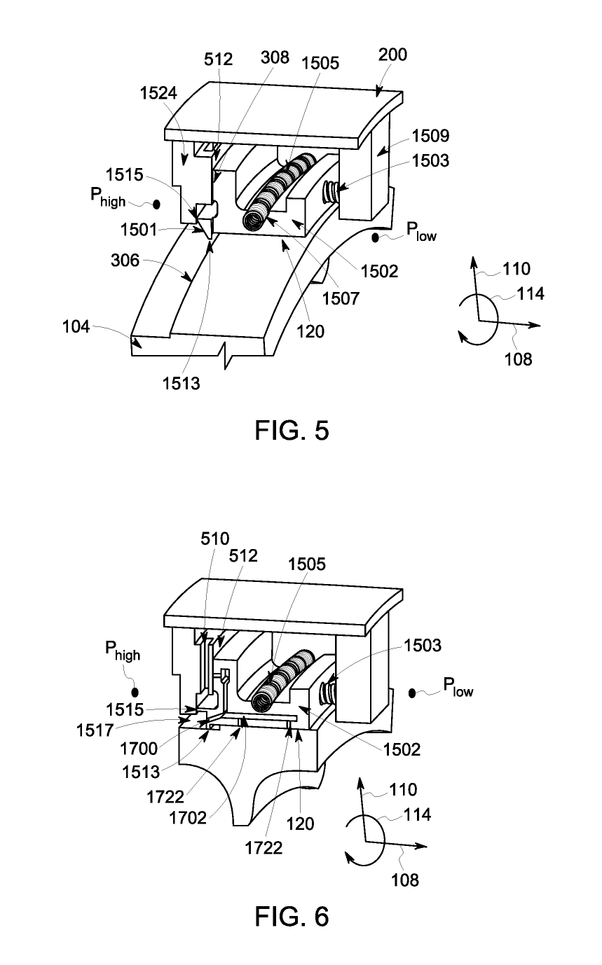

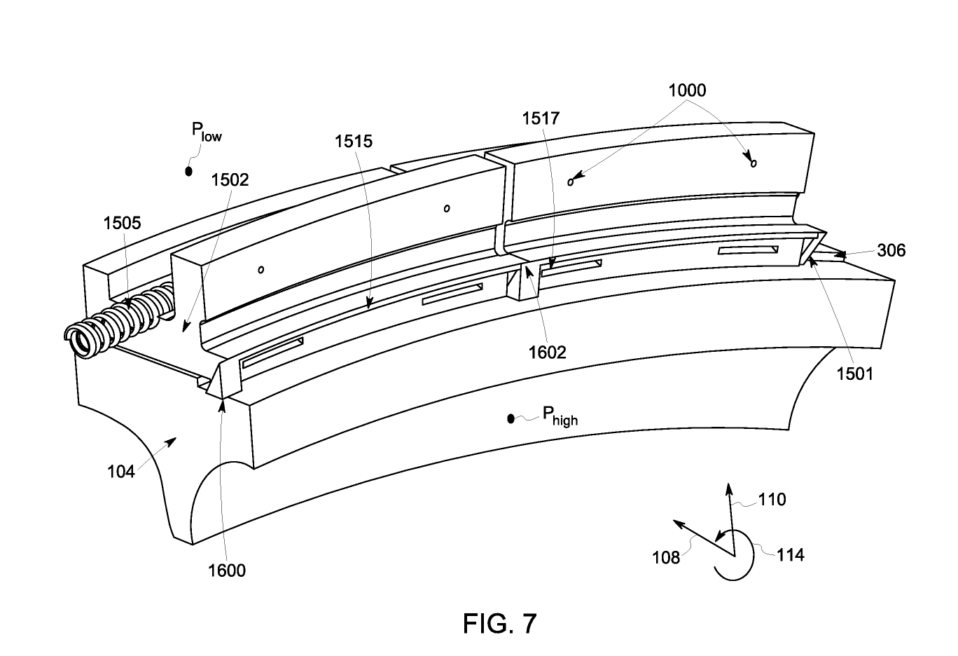

FIG. 5 illustrates a perspective view of a seal segment 1512 according to another embodiment. FIG. 6 illustrates a cross-sectional view of the seal segment 1512 shown in FIG. 5 according to one embodiment. FIG. 7 illustrates plural seal segments 1512 coupled with each other and engaged with the rotor 104 according to one embodiment. The seal segment 1512 can be used in the assembly 100 in place of one or more, or all, of the seal segments 112 shown and described herein.

The seal segment 1512 includes a shoe plate 1502 that can interlock with neighboring shoe plates 1502 of other seal segments 1512 via a slanted contact interface 1501 of the shoe plates 1502. This slanted interface 1501 allows for each shoe plate 1502 to move outward in the radial direction 108 without any restriction, but blocks (or reduces) leakage of fluid between neighboring shoe plates 1502. The shoe plates 1502 include elongated recesses or indentations 1507 that extend along or parallel to the circumferential direction 114. These recesses or indentations 1507 receive a garter spring or multiple garter springs 1505 inside the seal segments 1512.

The garter spring 1505 radially pushes the shoe plates 1502 inward. A single garter spring 1505 can extend around the entire circumference of the assembly 100 and the rotor 104, or two or more garter springs 1505 can extend within the seal segments 1512 and around the entire circumference of the assembly 100 and the rotor 104.

The seal segment 1512 includes a radial stator interface wall 1509 that is located opposite of a front cover plate 1524 of the seal segment 1512. The stator interface wall 1509 extends radially from a location close to the rotor 104 (e.g., closer to the rotor 104 than the stator interface element 200) to the stator interface element 200. The shoe plates 1502 also are supported with axial springs 1503. The axial springs 1503 are located between an interior surface of the stator interface wall 1509 and the shoe plate 1502, as shown in FIG. 5. The axial springs 1503 impart forces on the shoe plate 1502 to force the shoe plate 1502 and the contact interface 1501 in the direction that is opposite of the axial direction 108. The shoe plates 1502 include the load-bearing surfaces 120, and other features such as labyrinth seals, internal passages, etc., as described herein.

Returning to the description of the seal segment 112 shown in FIGS. 1 through 4, the shoe plate 202 includes one or more labyrinth teeth 302, 304 (shown in FIG. 3) facing the rotor 104 on the upstream end of the seal segment 112. The shoe plate 1502 of the seal segment 1512 shown in FIG. 5 includes a primary labyrinth tooth 1513 that corresponds to the labyrinth tooth 302 (and the accompanying description herein) and a secondary labyrinth tooth 1515 that corresponds to the labyrinth tooth 304 (and the accompanying description herein). The labyrinth tooth 302, 1513 is formed as a protrusion that juts out from the remainder of the shoe plate 202, 1502 in a direction toward the rotor 104 and that is opposite of the radial direction 110. The labyrinth tooth 302, 1513 can be elongated in a direction that is along or parallel to the circumferential direction 114. The labyrinth tooth 304, 1515 is formed as a protrusion that juts out from the remainder of the shoe plate 202, 1502 in a direction that is opposite but parallel to the axial direction 108. In the illustrated embodiment, the labyrinth teeth 302, 304 and the labyrinth teeth 1513, 1515 extend from the shoe plates 202, 1502 in perpendicular directions. Alternatively, the labyrinth teeth 302, 304 and the labyrinth teeth 1513, 1515 extend from the corresponding shoe plate 202, 1502 in non-perpendicular but transverse directions.

The labyrinth teeth 302, 304, 1513, 1515 form fluid seals between the sealing segment 112, 1512 and the rotor 104 that prevent or reduce passage of the high-pressure fluid from the upstream cavity of the rotary machine 102 to the downstream cavity of the rotary machine 102 between the seal assembly 100 and the rotor 104. The labyrinth tooth 302, 1513 can be referred to as a primary tooth or primary labyrinth tooth 302, 1513 that forms a primary seal between the seal segment 112, 1512 and the rotor 104. This seal is formed by the primary labyrinth tooth 302, 1513 being very close (e.g., within close proximity to) the rotor 104 during rotation of the rotor 104 relative to the stationary or non-rotating seal segment 112, 1512. For example, the outer end of the labyrinth tooth 302, 1513 may be closer to the rotor 104 than the other labyrinth tooth 304, 1515 and/or may be closer to the rotor 104 than the lower end (e.g., along the radial directions 110) of the front cover plate 124, 1524.

The labyrinth tooth 304, 1515 can be referred to as a secondary tooth or secondary labyrinth tooth 304, 1515 that forms a secondary seal between the front cover plate 124, 1524 and the shoe plate 202, 1502. This seal is formed by the secondary labyrinth tooth 304, 1515 being very close (e.g., within close proximity to) the front cover plate 124, 1524. For example, the outer end of the labyrinth tooth 304, 1515 may be closer to the front cover plate 124, 1524 than the other labyrinth tooth 302, 1513.

The labyrinth teeth 302, 304, 1513, 1515 are depicted as single tooth protrusions, but other embodiments with multiple protrusions forming a set of primary labyrinth teeth and/or multiple protrusions forming a set of secondary labyrinth teeth are also possible.

In certain embodiments, the opposite edges of the primary labyrinth tooth 302 in each seal segment 112 (e.g., the edges that are opposite to each other along the circumferential direction 114) can engage or abut the edges of the primary labyrinth teeth 302 in the neighboring seal segments 112 to maintain the primary seal around the circumference of the seal assembly 100. In certain embodiments, the opposite edges of the secondary labyrinth tooth 304 in each seal segment 112 (e.g., the edges that are opposite to each other along the circumferential direction 114) can engage or abut the edges of the secondary labyrinth teeth 304 in the neighboring seal segments 112 to maintain the secondary seal around the circumference of the seal assembly 100. In other embodiments, the opposite edges of the primary labyrinth tooth 302 in each seal segment 112 may have a small clearance (separation) from the edges of the primary labyrinth teeth 302 in the neighboring seal segments 112; thereby resulting in a segment gap. In some embodiments, this segment gap leakage is reduced using spline seals between neighboring seal segments 112, 1512. In other embodiments, the neighboring shoes 1502 are interlocked along the slanted faces or interfaces 1501 as shown in FIG. 7. For example, one end 1600 of a slanted interface 1501 in one seal segment 1512 can protrude away from the seal segment 1512 along the circumferential direction 114 (or in a direction that is opposite the circumferential direction 114) while an opposite end 1602 of the same slanted interface 1501 in the same seal segment 1512 can be recessed into the seal segment 1512. The recessed end 1602 of the slanted interface 1501 can be sized to receive the projected or protruding end 1600 of the neighboring or adjacent seal segment 1512, as shown in FIG. 7.

During operation of the rotary machine 102, the pressure of the fluid reduces from the high-pressure P_{high} to the low-pressure P_{low} across the primary seal formed by the labyrinth teeth 302 in the seal assembly 100. The cavities downstream of the primary seal labyrinth teeth 302 are connected to the overall downstream cavity of the rotary machine 102.

The position of the primary labyrinth seal near the spinning rotor 104 and formed by the primary labyrinth teeth 302 is maintained by the film-riding shoe plate 202, which has the load-bearing surface 120 facing the rotor 104. The film-riding shoe plate 202 generates a radial aerostatic-aerodynamic force that positions the primary labyrinth seal tooth 302, while the primary labyrinth seal tooth 302 forms the primary seal. For example, a small amount of the fluid passes through internal passages of the seal segment 112 (described below) and exits out of the ports 122 (shown in FIG. 1) through the load-bearing surface 120 that faces the rotor 104. The fluid exiting the seal segment 112 through the ports 122 forms the fluid film between the shoe plate 202 and the rotor 104. This film applies the aerostatic-aerodynamic force in radial directions 110 (or directions that are opposite to the radial directions 110) to cause the shoe plate 202, the primary labyrinth teeth 302 and seal segment 112 to float above (or maintain a separation distance from) the rotor 104. This primary labyrinth teeth 302 prevents additional fluid (not in the internal passages of the seal segments 112) from crossing over or through the gap between the seal segments 112 and the rotor 104.

The one or more primary seal labyrinth teeth 302 and the surface 120 of the film-riding shoe plate 202 ride on the rotor 104 at different radii of the rotor 104, as shown in FIGS. 3 and 4. The rotor 104 has a step 306 between the different radii of the rotor 104. The step 306 in the rotor 104 decelerates axial momentum of the fluid (e.g., momentum of the fluid in a direction along or parallel to the axial direction 108 or axis of rotation 108). This momentum can be created by a pressure drop in the fluid across the one or more labyrinth teeth 302. This enables the fluid film formed between the load-bearing surface 120 of the shoe plate 202 and the rotor 104 to remain unaffected by fluid leakage emanating from the primary seal formed by the primary labyrinth teeth 302 during movement of the rotor 104 and operation of the rotary machine 102.

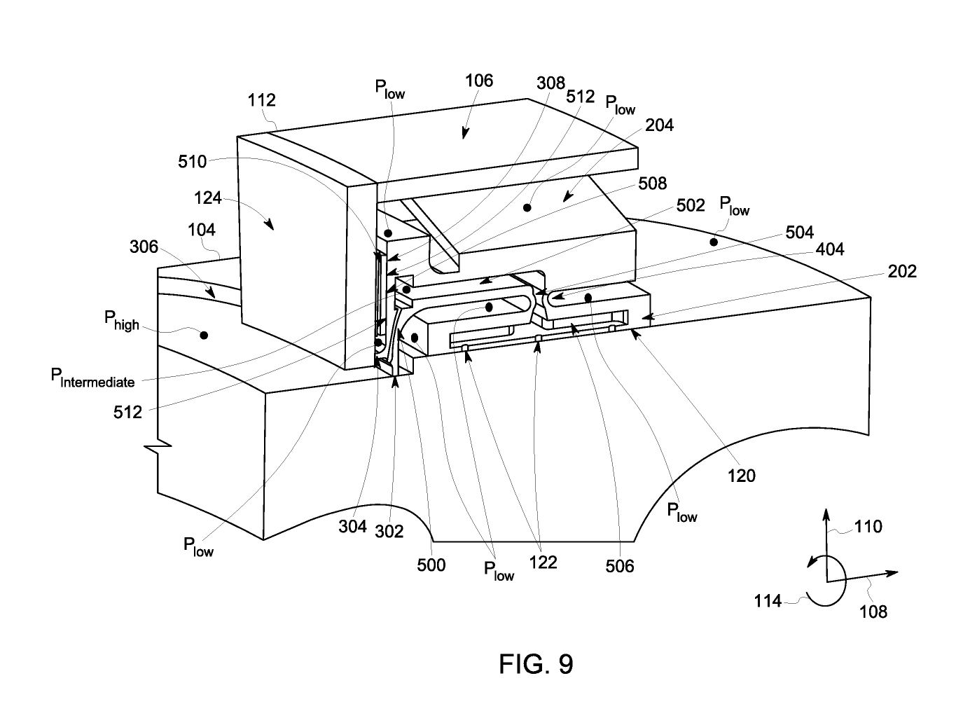

FIG. 9 illustrates a cross-sectional view of the seal segment 112 shown in FIG. 1 according to one embodiment. The load-bearing surface 120 of the shoe plate 202 has several of the ports 122 that direct fluid toward the rotor 104 (e.g., along or in a direction opposite to the radial direction 108). The shoe plate 202 has several internal hollow passages that feed at least some of the pressurized fluid to the ports 122 on the load-bearing surface 120 of the shoe plate 202. These passages include a feed passage 500, an upper or outer passage 502, a radial or interconnection passage 504, and a lower or inner passage 506. The feed passage 500 extends from an inlet located between the primary and secondary labyrinth teeth 302, 304 to the upper passage 502 (e.g., along a direction that is closer to being parallel to the radial directions 110 than the axial direction 108). The upper passage 502 extends along or parallel to the axial direction 108 toward the interconnection passage 504. The interconnection passage 504 is fluidly coupled with the upper passage 502 and extends along or parallel to the radial direction 110. The lower passage 506 is fluidly coupled with the interconnection passage 504 and extends along or parallel to the radial direction 110. The lower passage 506 is within the shoe plate 202 and is fluidly coupled with the ports 122 through the load-bearing surface 120 of the shoe plate 202.

With respect to the seal segment 1512 shown in FIG. 6, the load-bearing surface 120 of the shoe plate 1502 has several hydrostatic ports 1722 that direct fluid toward the rotor 104 (e.g., along or in a direction opposite to the radial direction 108). The shoe plate 1502 has several internal hollow passages that feed at least some of the pressurized fluid to the ports 1722 on the load-bearing surface 120 of the shoe plate 1502. These passages include a feed passage 1700 and an interconnection passage 1702. The feed passage 1700 extends from an inlet located between the primary and secondary labyrinth teeth 1513, 1515 to the interconnection passage 1702 (e.g., along a direction that is closer to being parallel to the radial directions 110 than the axial direction 108). The interconnection passage 1702 extends along or parallel to the axial direction 108 toward the hydrostatic ports 1722. The interconnection passage 1702 is fluidly coupled with the hydrostatic ports 1722 through the load-bearing surface 120 of the shoe plate 1502. Fluid is received into the feed passage 1700 through one or more feedholes or feed slots 1517.

The internal passages 500, 502, 504, 506, 1700, 1702 in the seal segments 212, 1512 are pressurized by fluid from the high-pressure or upstream side of the seal assembly 100. The ports 122, 1722 through the load-bearing surface 120 of the shoe plate 202, 1502 allow the film-riding shoe plate 202, 1502 to operate with an aerostatic film formed by the fluid moving through the passages 500, 502, 504, 506, 1700, 1702 and out of the seal segment 112, 1512 through the ports 122, 1722. Additionally, the load-bearing surface 120 of the shoe plate 202, 1502 may be machined with a radius larger than the radius of the rotor 104. This radii curvature mismatch allows the load-bearing surface 120 to form a converging-diverging (along the tangential direction of the rotor 104) thin film wedge between the load-bearing surface 120 and the spinning rotor 104. This converging-diverging fluid film leads to the generation of an aerodynamic force in the presence of rotation of the rotor 104 (relative to the seal assembly 100). Optionally, instead of the curvature mismatch, the rotor 104 or the load-bearing surface 120 of the shoe plate 202 may also have aerodynamic features such as spiral grooves, and/or Rayleigh steps to generate aerodynamic force in the presence of rotation of the rotor 104.

The presence of aerostatic ports and aerodynamic features (spiral grooves, Rayleigh steps or curvature mismatch) results in a high-stiffness fluid film being formed and separating the shoe plate 202, 1502 from the rotor 104. The characteristics of the film are such that the pressure of the fluid in the film increases with a corresponding reduction in thickness of the film, and vice versa. For example, as the rotor 104 moves closer to the seal assembly 100 during rotation of the rotor 104, the fluid film between the rotor 104 and the seal assembly 100 becomes thinner. But, the decreasing thickness of the fluid film also causes the pressure of the fluid in the film to increase. The increase in pressure of fluid in the film increases the forces exerted on the seal assembly 100 and the rotor 104 to prevent the rotor 104 from abutting, contacting, or otherwise engaging the seal assembly 100. This prevents wear of the seal assembly 100.

This characteristic of the fluid film pressure along with the flexible element 204, 1505 pushing or urging the shoe plate 202, 1502 toward the rotor 104 results in the shoe plate 202, 1502 (and the load-bearing surface 120 of the shoe plate 202, 1502) closely following or tracking radial incursions of the rotor 104, such as when the rotor 104 expands during rotation. The film-riding shoe plate 202, 1502 maintains a very small distance (e.g., 5 to 25 microns) between the rotor 104 and the load-bearing surface 120 using aerodynamic and aerostatic forces, thereby positioning the primary labyrinth seal formed by the primary labyrinth teeth 302, 1513 very close to the rotor 104.

Movement of the rotor 104 in or along the radial direction 110 may be caused by or result from thermal growth or expansion of the rotor 104, centrifugal growth or movement of the rotor 104 due to rotation of the rotor 104, and/or vibratory motion of the rotor 104 along the radial direction 110. The high stiffness of the thin fluid film between the shoe plate 202, 1502 and the rotor 104 is maintained and helps with tracking the radial motion of the rotor 104. This radial tracking (or following) of the rotor 104 enables the primary labyrinth seal formed by the primary labyrinth teeth 302, 1513 to maintain a small clearance gap between the rotor 104 and the teeth 302, 1513. This radial tracking also eliminates or reduces relative motion between the rotor 104 and the primary labyrinth teeth 302, 1513 along or in the radial directions 110 (and/or in opposite directions).

The elimination of relative radial motion between the primary labyrinth seal teeth 302 and the rotor 104 leads to non-degrading labyrinth seal teeth 302, 1513 and sustained low-leakage performance otherwise not possible with other labyrinth seals, which undergo degradation upon relative radial motion between the rotor 104 and the seal teeth.

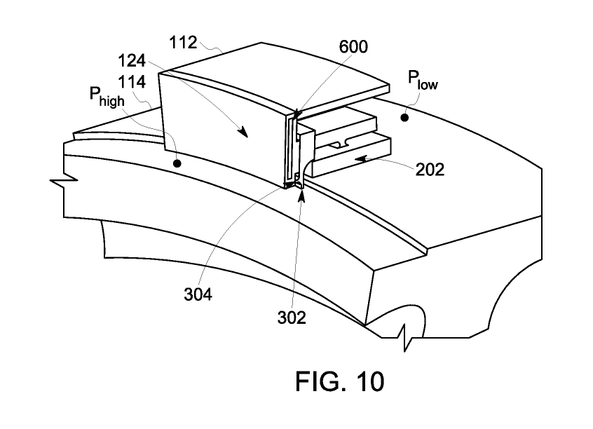

The seal assembly 100 is shielded on the upstream side with the front cover plate 124, 1524 that can be a continuous plate spanning 360 degrees (e.g., the front cover plate 124, 1524 is a continuous body that extends across the upstream side of all seal segments 112 in the seal assembly 100), or may be formed from several sub-segments. In one embodiment, each seal segment 112 is shielded by a separate front cover plate 124, 1524, overall leading to a segmented front cover plate. In this instance, the number of front cover plate segments 124, 1524 is equal to the number of seal segments 112. In another embodiment, a segment of the front cover plate 124, 1524 simultaneously shields several seal segments 112. For example, a single front cover plate 124, 1524 may extend across all or a part of two or more different seal segments 112. In embodiments involving a segmented front cover plate 124, 1524, the gap between neighboring front cover plate segments 124, 1524 can be sealed with intersegment seals such as spline seals. FIG. 10 illustrates another embodiment of the seal segment 112 that includes such a spline seal slot 600. A spline seal (not depicted) typically formed with sheet metal is installed in the spline seal slot 600 of neighboring front plate segments to block/reduce leakage between front plate segments.

The labyrinth teeth 302, 304 form a first (or primary) seal between the rotor 104 and the seal assembly 100. While the individual labyrinth teeth 302, 304 each form respective primary and secondary seals, together these primary and secondary labyrinth seals form a primary seal of the entire seal segment 112 and/or of the entire seal assembly 100. The seal formed by the primary and secondary labyrinth teeth 302, 304 can be referred to herein as a primary segment seal or primary assembly seal.

The distance between the secondary labyrinth tooth 304 and a back or internal side 512 (shown in FIG. 9) of the front cover plate 124 is set by a self-adjusting gap behavior created by the aerostatic ports for the secondary seal 308. Note that surface 512 represents one or multiple radially-extending surfaces that face the shoe 202 and the secondary labyrinth tooth 304. The secondary seal leakage past the secondary labyrinth seal formed by the labyrinth tooth 304 passes through cross-over ports or holes 510 (shown in FIG. 9) that radially extend in the front cover plate 124. In the illustrated embodiment, the cross-over ports 510 for the secondary seal leakage are present in the front cover plate 124. Alternatively, cross-over ports 124 in the shoe plate 202 are also possible. The cross-over ports 124 allow removal of the leaked fluid past the seal formed between the secondary labyrinth tooth 304 and the front cover plate 124 through the cross-over ports 124, thereby resulting in low pressure fluid in an internal cavity that is radially outward of the secondary seal tooth 304. This cavity is located at the “Plow” in FIG. 9 that is above the tooth 304 along the radial direction 110.

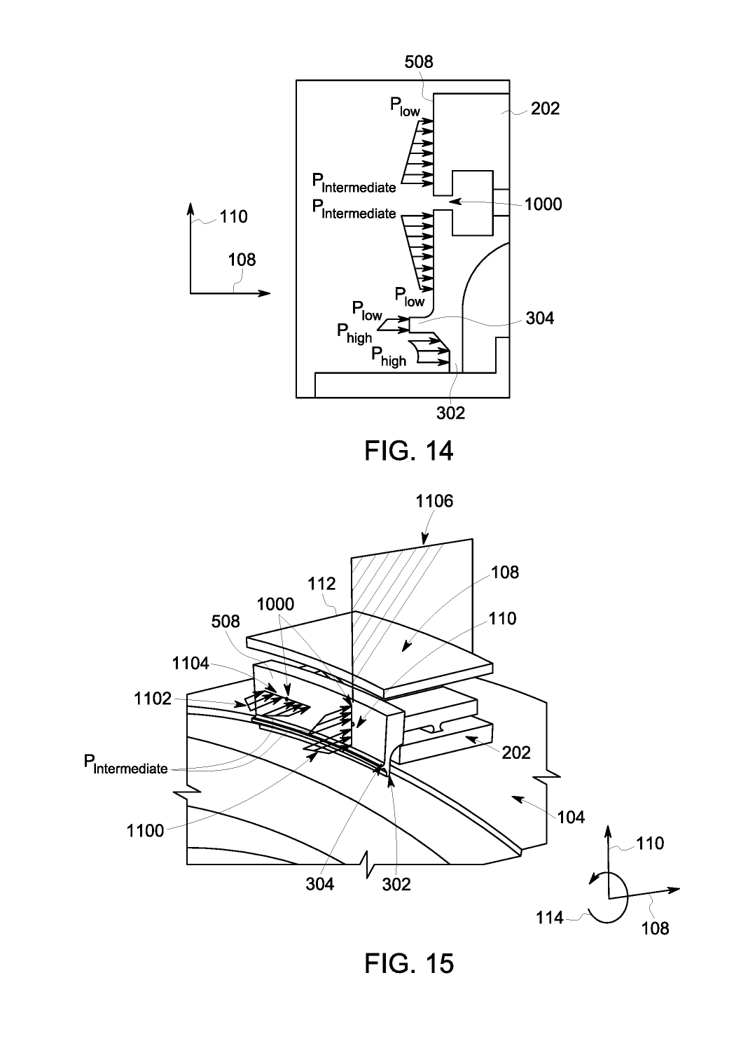

During pressurized operation, the radial or vertical face 508 of the shoe plate 202 is separated from an opposing radial or vertical face 512 of the front cover plate 124 by a thin fluid film referred to as a secondary-seal fluid film 308. The secondary-seal fluid film 308 is formed by the fluid supplied from aerostatic ports 1000 (shown in FIG. 14 and described below). The internal passages in the shoe plate 202 are used for supplying the aerostatic ports 122 with pressurized fluid from the high-pressure or upstream side of the seal assembly 100. The secondary seal fluid film 308 self-adjusts by increasing or decreasing in thickness due to changes in fluid pressure to prevent components of the seal segment 112 from contacting and wearing on each other, while maintaining a seal that prevents a significant portion of the fluid from passing between the shoe plate 202 and the front cover plate 124.

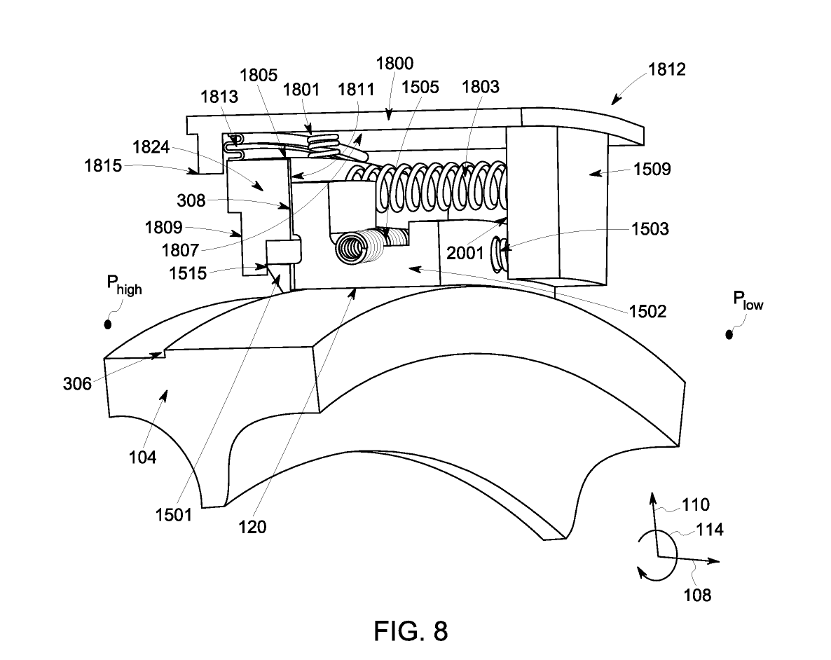

FIG. 8 illustrates a perspective view of another embodiment of a seal segment 1812. The seal segment 1812 can be used in the seal assembly 100 in place of one or more, or all, seal segments 112 and/or 1512. The seal segment 1812 includes many of the same components of the seal segment 112 and/or 1512, as shown in FIG. 8.

The seal segment 1812 can be shielded on the upstream side of the seal assembly 100 with a flexibly-mounted front cover plate 1824. The flexibly-mounted front cover plate 1824 can be a continuous plate spanning 360 degrees (e.g., the front cover plate 1824 is a continuous body that extends across the upstream side of all seal segments 1812 in the seal assembly 100), or may be formed from several sub-segments. The front cover plate 1824 is flexibly supported in the radial direction 110 with one or more radial springs 1801, and flexibly supported in the axial direction 108 with one or more axial springs 1803. The radial springs 1801 are compressed between a top side 1805 of the front cover plate 1824 and an opposing bottom side 1807 of a stator interface element 1800 of the seal segment 1812. The radial spring(s) 1801 apply a force onto the top side 1805 of the front cover plate 1824 in a direction that is opposite the radial direction 110 to assist in establishing and/or maintaining the secondary seal between the labyrinth tooth 1515 of the shoe plate 1502 and the front cover plate 1824. The axial spring(s) 1803 are compressed between an interior side or surface 2001 of the stator interface wall 1509 and an opposing interior side or surface 1811 of the front cover plate 1824. A downwardly extending axial stop protrusion 1815 of the stator interface 1800 extends in a direction that is opposite of the radial direction 110. This protrusion 1815 also can be referred to as an axial stop. The stop 1815 limits or stops movement of the front cover plate 1824 by the axial spring(s) 1803 in a direction that is opposite of the axial direction 108. In such embodiments, the flexibly mounted front cover plate 1824 has more degrees of freedom (compared to the rigid-mounted front cover plate described above) to form a robust film-riding secondary seal. The flexible-mounted front cover plate 1824 optionally can include a stationary W-shaped seal body 1813 between the movable front cover plate 1824 and the stationary stator interface 1800.

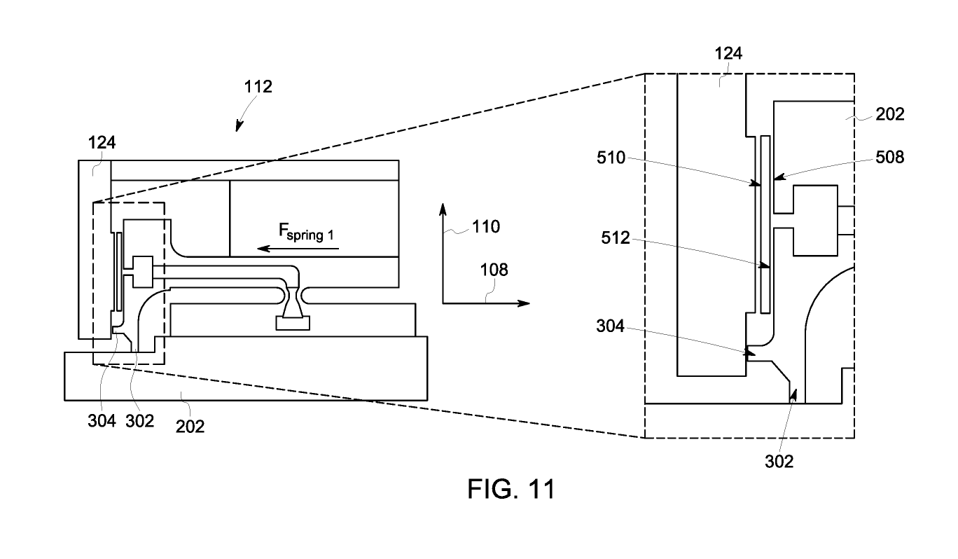

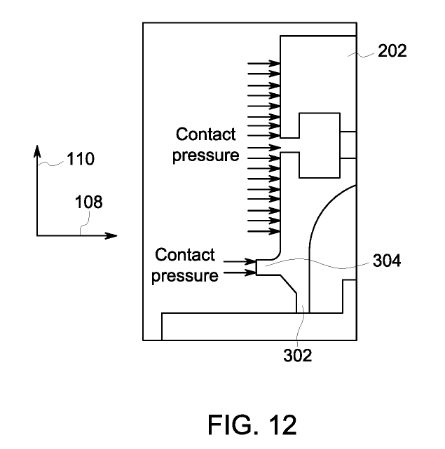

FIGS. 11 through 14 illustrate cross-sectional views and corresponding magnified views of the seal segment 112 shown in FIG. 1 to demonstrate operation of the self-adjusting secondary-seal 308 shown in FIG. 3 according to one example. FIGS. 11 and 12 show the seal segment 112 and shoe plate 202 prior to the presence of the high-pressure fluid (e.g., before pressurization of the rotary machine 102). Before pressurization, each seal segment 112 is assembled such that the front plate 124 of each seal segment 112 physically contacts or abuts the shoe plate 202 and the secondary labyrinth seal tooth 304 in the same seal segment 112. This is shown in FIG. 11 where the front face or surface 508 of the shoe plate 202 abuts the back face or surface 512 of the front cover plate 124. FIG. 12 shows the contact pressure applied onto the front surfaces of the shoe plate 202 by the front cover plate 124. The arrows in FIG. 12 show the direction in which the contact pressure is applied onto the shoe plate 202 by the front cover plate 124. This contact pressure arises because, in the non-pressurized state, the front plate 124 pushes against the shoe plate 202 and the secondary labyrinth tooth 304 in the axially aft direction (toward the right in FIGS. 11 and 12). This contact pressure also results in a spring reaction force F_{spring1}, as shown in FIG. 11. For example, in a non-pressurized state, the front cover plate can push the shoe plate and the flexible element in the axial direction, and preload or pre-compress the flexural element 204 to create a contact force between the front plate and the shoe plate.

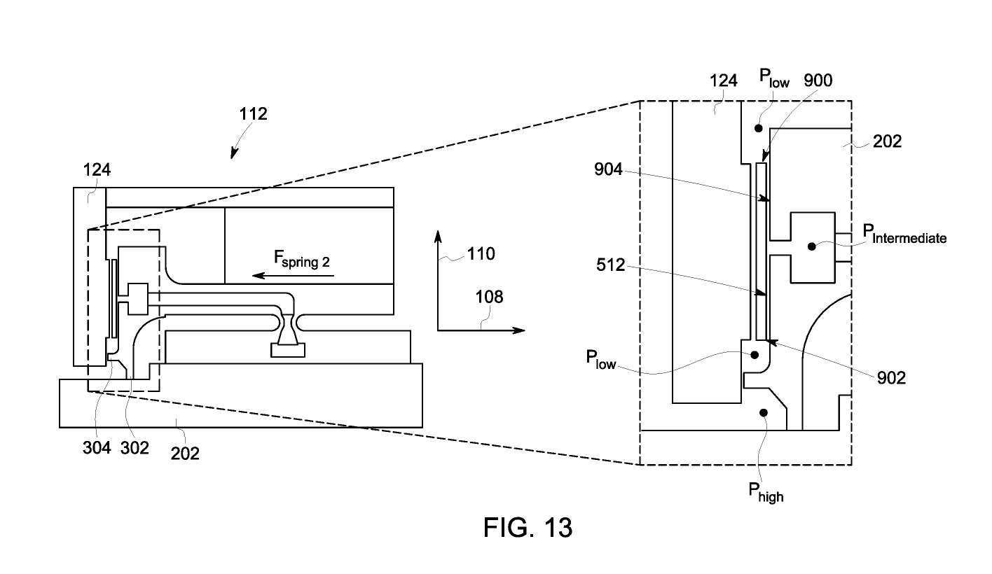

FIGS. 13 and 14 show the seal segment 112 in the presence of the high-pressure fluid (e.g., after pressurization of the rotary machine 102). Upon pressurization, the pressurized fluid passes through the internal passages and flows in the axially forward direction (from right to left in FIGS. 13 and 14, or in a direction that is opposite of the axial direction 108) from the shoe plate 202 to impinge on the vertical aft face 512 of the front cover plate 124. The pressurized jets impinging on the front plate aft vertical face 512 result in a pressure distribution as shown in FIG. 14, with the directions of the arrows in FIG. 14 representing the direction in which the fluid applies force onto the shoe plate 202 and the size (e.g., length) of the arrows indicating the magnitude of the corresponding force at that location (e.g., longer arrows indicate greater force while shorter arrows indicate lesser force).

The film pressures vary between a value of P_{intermediate} near an aerostatic port 1000 of the internal passages of the shoe plate 202 to a value of P_{low} on either upper and lower radial ends 900, 902 of the interface between the shoe plate 202 and the front cover plate 124. The pressure distribution shown in FIG. 14 is representative of the pressure value in a particular radial-axial plane and deviations from this profile are expected in locations that are farther from the aerostatic port 1000 in the circumferential direction 114 (shown in FIG. 1).

FIG. 15 illustrates a front perspective view of the seal segment 112 shown in FIG. 1 with the front cover plate 124 removed according to one example. FIG. 17 illustrates a cross-sectional view of the seal segment 112 shown in FIG. 15 along a cross-sectional plane 1106 shown in FIG. 15. A radial direction distribution 1100 of the fluid pressures exerted onto the front surface 508 of the shoe plate 202 along a radial direction 110 and a tangential direction distribution 1102 of the fluid pressures exerted onto the front surface 508 of the shoe plate 202 along a tangential direction 1104 are shown, with longer arrows indicating greater pressure than shorter arrows.

This pressure acts on the shoe plate 202 and pushes the shoe plate 202 along the axially aft direction (e.g., along or parallel to the axial direction 108). This also is shown in FIG. 14 where the pressures on the vertical face or front surface 508 of the shoe plate 202, the pressures on the secondary seal labyrinth tooth 304 and the high-pressure on the vertical face radially beneath the secondary seal labyrinth tooth 304 combine to push the shoe plate 202 toward the axially aft direction (left to right in FIG. 14). This pressure replaces the contact force or pressure shown in FIG. 12. This leads to a floating secondary seal arrangement without physical contact (or with very little physical contact) between the front cover plate 124 and the shoe plate 202. For example, a separation gap 904 (shown in FIG. 13) between the front cover plate 124 and the shoe plate 202 is created by the fluid pressure shown in FIG. 14. This creates a frictionless film-riding secondary seal of the seal segment 112. The sum of pressure forces pushing the shoe plate 202 toward the axially aft direction is balanced by a reaction force (F_{spring2} in FIG. 13) from the flexible element 204.

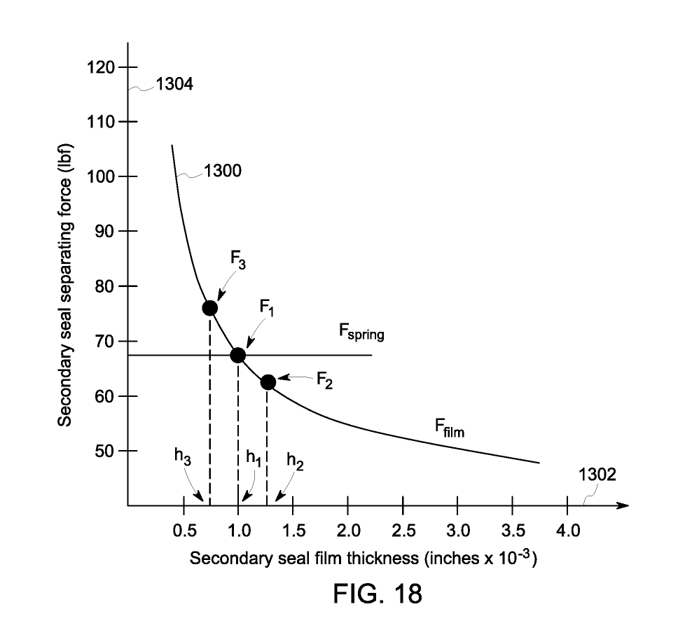

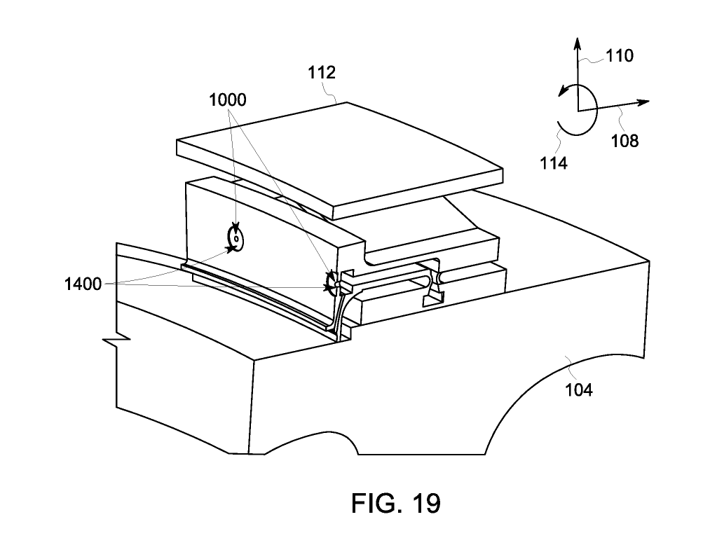

The pressure distribution on the vertical face 508 of the shoe plate 202 creates a secondary seal separating force. The magnitude of this separating force depends on the thickness of the secondary seal film formed in the gap 904 between the front cover plate 124 and the shoe plate 202. FIG. 18 illustrates a relationship 1300 between the thickness of the secondary seal fluid film formed in the gap 904 between the front cover plate 124 and the shoe plate 202 and the force exerted on the face 508 of the shoe plate 202 according to one example. This relationship 1300 is shown alongside a horizontal axis 1302 representative of the thickness of the secondary seal fluid film formed in the gap 904 between the front cover plate 124 and the shoe plate 202. The relationship 1300 also is shown alongside a vertical axis 1304 representative of the force exerted on the face 508 of the shoe plate 202 by the fluid. The fluid pressure force increases when the secondary seal film thickness reduces, but the fluid pressure force decreases when the secondary seal film thickness increases. The fluid pressures (e.g., P_{high}, P_{low}, P_{intermediate}), the flow resistances in the shoe internal passages 500, 502, 504, 506, the diameter of the ports 1000, and/or the diameter of counterbores (shown and described in FIG. 19) can be modified or controlled to achieve the desired separating force versus film thickness relationship. Similarly, the thickness, length, and/or material strength of the flexible element 204 can be designed or controlled to achieve the desired stiffness of the flexible element 204 and F_{spring} values.

For example, the F_{spring} and the fluid pressure force that separates the shoe plate 202 and the front cover plate 124 may be equal and intersect when the secondary seal film thickness is 0.001 inch (e.g., 0.0254 millimeters). Thus, for a film thickness of 0.001 inches (e.g., 0.0254 millimeters), the resulting secondary seal separating force is F₁, which is equal to the F_{spring} value. If a force imbalance or relative thermal motions lead to the reduction of the secondary seal film thickness, the secondary seal separating force will increase (e.g., to a value of F₃). This increased force will cause further separation of the shoe plate 202 from the front cover plate 124 and restore the secondary seal film thickness to 0.001 inches (e.g., 0.0254 millimeters). If a force imbalance or relative thermal motions lead to an increase in the secondary seal film thickness, the secondary seal separating force will decrease (e.g., to a value of F₂). This decreased force will allow the flexible element 204 (shown in FIG. 4) to push the shoe plate 202 toward the front cover plate 124 and restore the secondary seal film thickness to 0.001 inches (e.g., 0.0254 millimeters). The flexible element 204 pushes the shoe plate 202 in the axially forward direction (opposite to 108) because the flexible element is preloaded as described previously.

An alternative embodiment is the embodiment depicted in FIG. 5. In this case, the pre-load or contact force during the non-pressurized state is achieved because the axial spring 1503 pushes the shoe plate 1502 in the axially forward direction (opposite to the axial direction 108). The formation and operation of the secondary seal fluid film in this embodiment is similar or identical to the embodiment described in FIGS. 11 through 15, FIG. 17, and FIG. 18.

With respect to the embodiment shown in FIG. 8, the seal segment 1812 has the flexibly-mounted front cover plate 1824 that, in the non-pressurized state, may or may not be in physical contact with the shoe plate 1502. For example, the axial spring 1803 of the front cover plate 1824 may push the front cover plate 1824 in an axially forward direction (that is opposite to the axial direction 108 shown in FIG. 8). This pushes the front cover plate 1824 against the axial stop 1815 to a position where the front cover plate 1824 loses physical contact with the shoe plate 1502 when the seal segment 1812 is in the non-pressurized state. The axial position of the shoe plate 1502 can be determined by the axial spring 1503 of the shoe plate 1502. Upon pressurization, the flexibly-mounted front cover plate 1824 overcomes the spring resistance of the axial spring 1803 (due to the introduction of fluid pressure at a front side or surface 1811 of the front cover plate 1824 and the shoe plate 1502. This pressure moves the front cover plate 1824 slightly in the axial direction 108. Additionally (and, optionally, simultaneously), upon pressurization, the shoe plate 1502 also moves in the axial direction 108 due to pressurization applied by the fluid pressure in the secondary seal 308. Depending on the relative stiffness of the axial springs 1503, 1803 and/or the magnitude of the pressure forces applied by the fluid pressure, the front cover plate 1824 may move to reduce the separation distance or gap between the front cover plate 1824 and the shoe plate 1502. As described above, a secondary seal fluid film is formed between the flexibly-mounted front cover plate 1824 and the shoe plate 1502. This secondary seal fluid film ensures that the flexibly-mounted cover plate 1824 and the shoe plate 1502 do not contact one another and form a frictionless secondary seal 308. Alternatively, in the non-pressurized state, the flexibly-mounted cover plate 1824 and the shoe plate 1502 may start with contact and a pre-loaded axial spring 1503, and later develop a secondary seal fluid film upon pressurization.

The arrangement of the aerostatic ports 1000 (with or without the counterbores shown and described in FIG. 19 described below) creates a self-adjusting secondary seal film thickness. This results in the shoe maintaining a self-adjusting small separation between the shoe plate 202 and the front cover plate 124, thereby resulting in small secondary seal leakage. Furthermore, because the shoe plate 202 is not in physical contact with the front cover plate 124, friction forces between the shoe plate 202 and front cover plate 124 that may result in radial force balance uncertainties are eliminated or reduced.

FIG. 19 illustrates a cross-sectional view of the seal segment 112 shown in FIG. 1 with counterbores 1400 around the aerostatic ports 1000 according to one embodiment. The counterbores 1400 can be shallow depressions (e.g., typically 0.001 to 0.020 inches deep, or 0.0254 to 0.508 millimeters deep, but other depths may be used) around the ports 1000. These counterbores 1400 can improve the stiffness of the secondary seal fluid film (e.g., the slope of the relationship 1300 shown in FIG. 18). The aerostatic ports 1000 on the load-bearing surface 120 of the shoe plate 202 optionally may include similar or identical counterbores to improve the stiffness of the film established between the rotor 104 and the shoe plate 202.

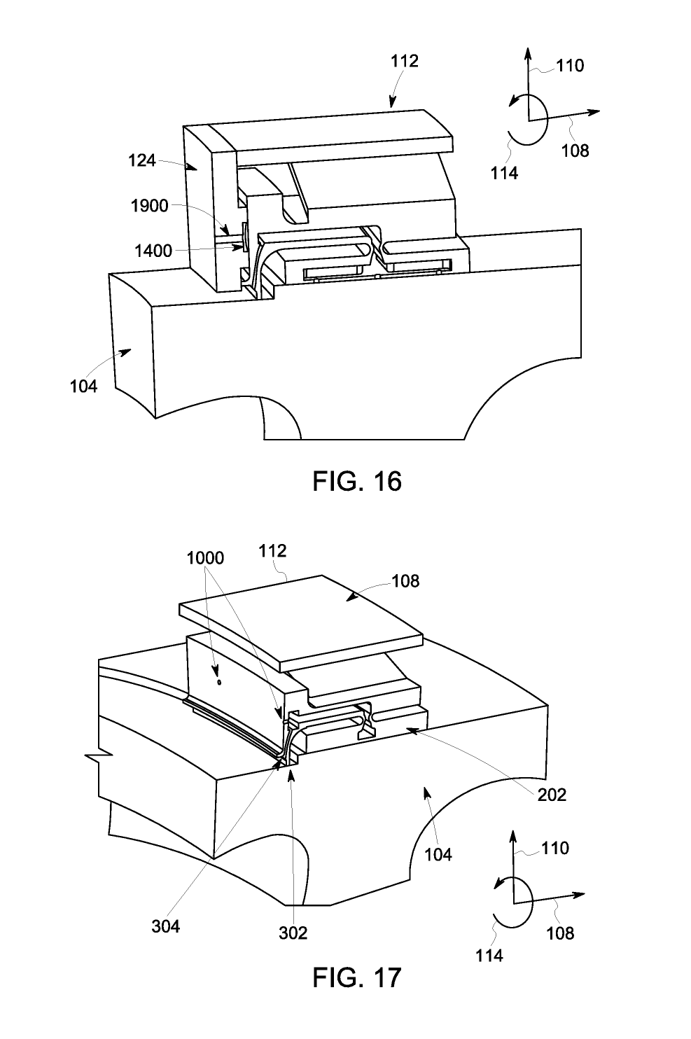

FIG. 16 illustrates a cross-sectional view of another embodiment of the seal segment 112 shown in FIG. 1. As shown in FIG. 16, the front cover plate 124 can include hydrostatic feed ports 1900 that direct fluid pressure into the seal segment 112 for the secondary seal fluid film seal 308. The counterbores 1400 may also be present in the front cover plate 124. These hydrostatic ports 1900 and/or counterbores 1400 may be exclusively present on the front cover plate or in combination with the hydrostatic ports/internal passages shown in the previous embodiments.

A method for manufacturing the seal segments 112 described herein can include forming one or more seal segments 112 of the seal assembly 100 for the rotary machine 102 using additive manufacturing. The seal segments 112 are shaped to be positioned circumferentially intermediate to the stationary housing 106 and the rotor 104 of the rotary machine 102. Forming the seal segments 112 can include forming the stator interface element 200, the radially oriented front cover plate 124, and the shoe plate 202 that is movably supported by the stator interface element using additive manufacturing. This process might include additively forming the front cover plate, the shoe plate, the stator interface element, and/or the flexible element as one single assembly. Alternatively, each of these items may be formed additively and separately, and assembly together with joining processes such as bolting, welding, brazing etc. This additive manufacturing may be followed by precision machining operations to achieve desired surface finish and tight tolerances on critical dimensions. The fabrication process may be followed by coating process to apply low wear, low friction coatings on the load-bearing surface of the shoe plate or the secondary seal face of the shoe.

In one embodiment, a seal assembly for a rotary machine includes plural seal segments disposed circumferentially intermediate to a stationary housing and a rotor. One or more of the seal segments includes a stator interface element, a radially oriented front cover plate, and a movably supported shoe plate. The shoe plate includes one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid through the shoe plate or through the front cover plate, and between the radial surface of the shoe plate and the front cover plate to form the frictionless secondary seal.

Optionally, the frictionless secondary seal formed by the radial surface and the one or more internal passageways of the shoe plate or the front cover plate is self-correcting based on a magnitude of axial force applied to the front cover plate and an axial force from the shoe plate.

Optionally, the frictionless secondary seal is self-correcting in that, as an axial dimension of a gap between the radial surface of the shoe plate and the cover plate increases, a support force applied to the shoe plate along an axial direction and a fluid pressure applied by the secondary seal film (between the front cover plate and the shoe plate) change in magnitude to restore the axial dimension by decreasing the gap to a previous equilibrium position and, as the axial dimension of the gap between the radial surface of the shoe plate and the cover plate decreases, the support force applied to the shoe plate along the axial direction and the fluid pressure applied by the secondary seal film (between the front cover plate and the shoe plate) change in magnitude to restore the axial dimension by increasing the gap to the previous equilibrium position.

Optionally, the one or more seal segments also includes one or more flexible elements (non-restrictive examples are bellows, springs, and/or flexures) disposed between the shoe plate and the stator interface element. The one or more flexible elements can be configured for aiding a radial movement of the shoe plate relative to the stator interface element and configured for providing axial spring support for the shoe plate.

Optionally, the one or more seal segments are spring-loaded in the radially inwards direction using a Garter spring.

Optionally, the one or more labyrinth teeth include an axial tooth axially projecting toward the front cover plate and a radial tooth radially projecting toward the rotor.

Optionally, the axial tooth is positioned such that at least some of the fluid passes between the axial tooth and the front cover plate, and further flows through at least one cross-over port present in the front cover plate or at least one cross-over port present in the shoe.

Optionally, the shoe plate is positioned to be subjected to hydrodynamic or aerodynamic forces due to one or more of a presence of curvature mismatch, spiral grooves on the rotor, spiral grooves on the shoe plate, or Rayleigh steps on the shoe plate.

Optionally, the shoe plate is positioned to be subjected to a hydrostatic or aerostatic force due to a presence of high-pressure fluid jets emanating from internal cavities in the shoe plate and impinging on the rotor.

Optionally, the seal assembly is stationary and rides on the rotor during spinning of the rotor due to one or more hydrodynamic self-correcting forces or hydrostatic self-correcting forces.

Optionally, the shoe plates of the seal segments are separated from each other by a segment gap.

Optionally, the shoe plates of neighboring seal segments of the seal segments are interlocked with slanted faces to reduce segment leakage.

Optionally, the assembly also includes one or more flexural pivots that flex to allow for rolling and pitching motions of the shoe plate.

In one embodiment, a method includes forming one or more seal segments of a seal assembly for a rotary machine using additive manufacturing. The one or more seal segments are shaped to be positioned circumferentially intermediate to a stationary housing and a rotor of the rotary machine. Forming the one or more of the seal segments includes forming a stator interface element, a radially oriented front cover plate, and a shoe plate using additive manufacturing. The shoe plate is formed using additive manufacturing to include one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid from outside of the shoe plate, through the shoe plate, and between the radial surface of the shoe plate and the front cover plate to form the frictionless secondary seal.

Optionally, the one or more seal segments are formed using additive manufacturing such that the frictionless secondary seal formed by the radial surface and the one or more internal passageways of the shoe plate or the one or more internal passageways of the front plate is self-correcting based on a magnitude of axial force applied to the front cover plate and an axial force from the shoe plate.

Optionally, the one or more seal segments are formed using additive manufacturing such that the frictionless secondary seal is self-correcting in that, as an axial dimension of a gap between the radial surface of the shoe plate and the cover plate increases, a support force applied to the shoe plate along an axial direction and a fluid pressure applied by the secondary seal film (between the front cover plate and the shoe plate) change in magnitude to restore the axial dimension by decreasing the gap to a previous equilibrium position and, as the axial dimension of the gap between the radial surface of the shoe plate and the cover plate decreases, the support force applied to the shoe plate along the axial direction and the fluid pressure applied by the secondary seal film (between the front cover plate and the shoe plate) change in magnitude to restore the axial dimension by increasing the gap to the previous equilibrium position..

Optionally, the one or more seal segments are formed using additive manufacturing such that the one or more seal segments also includes one or more flexible elements disposed between the shoe plate and the stator interface element, and such that the one or more flexible elements are configured for aiding a radial movement of the shoe plate relative to the stator interface element and configured for providing axial spring support for the shoe plate.

In one embodiment, an assembly includes plural seal segments shaped to be disposed circumferentially between a stator and a rotor of a rotary machine. At least one of the seal segments includes a stator interface plate positioned to face the stator, a front cover plate in contact with the stator interface plate and positioned to radially extend between the stator and the rotor, and a shoe plate having a radial face that opposes the front cover plate and a bearing surface positioned to face the rotor. The shoe plate and/or the front plate has one or more internal passages shaped to direct fluid from outside of the at least one seal element to a gap in a seal between the radial face of the shoe plate and the front cover plate. The one or more internal passages are shaped to direct the fluid to the gap to reduce or eliminate friction between the radial face of the shoe plate and the front cover plate.

Optionally, the shoe plate also includes an axially oriented tooth that forms the seal between the radial face of the shoe plate and the front cover plate by projecting toward the front cover plate.

Optionally, the seal formed by the radial surface and the one or more internal passageways of the shoe plate is self-correcting based on a magnitude of axial force applied to the front cover plate.

Optionally, the gap in the seal between the radial face of the shoe plate and the front cover plate changes size responsive to changes in pressure in the fluid.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A seal assembly for a rotary machine, the seal assembly comprising:
plural seal segments disposed circumferentially intermediate to a stationary housing and a rotor, wherein one or more of the seal segments includes:
a stator interface element;
a radially oriented front cover plate; and
a movably supported shoe plate, wherein the shoe plate comprises one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid, through the shoe plate or through the front cover plate, and between the radial surface of the shoe plate and the front cover plate to form the frictionless secondary seal.

2. The seal assembly of claim 1, wherein the frictionless secondary seal formed by the radial surface and the one or more internal passageways of the shoe plate or the front cover plate is self-correcting based on a magnitude of film pressure applied to a front radial surface of the shoe plate and an axial support force applied to the shoe plate.

3. The seal assembly of claim 2, wherein the frictionless secondary seal is self-correcting in that, as an axial dimension of a gap between the radial surface of the shoe plate and the cover plate increases, a support force applied to the shoe plate along an axial direction and a fluid pressure applied by the frictionless secondary seal between the front cover plate and the shoe plate changes in magnitude to restore the axial dimension by decreasing the gap to a previous equilibrium position and, as the axial dimension of the gap between the radial surface of the shoe plate and the cover plate decreases, the support force applied to the shoe plate along the axial direction and the fluid pressure applied by the frictionless secondary seal between the front cover plate and the shoe plate changes in magnitude to restore the axial dimension by increasing the gap to the previous equilibrium position.

4. The seal assembly of claim 1, wherein the one or more seal segments also includes one or more flexible elements disposed between the shoe plate and the stator interface element, and wherein the one or more flexible elements are configured for aiding a radial movement of the shoe plate relative to the stator interface element and configured for providing axial spring support for the shoe plate.

5. The seal assembly of claim 1, wherein the one or more seal segments are spring-loaded in the radially inwards direction using a Garter spring.

6. The seal assembly of claim 1, wherein the one or more labyrinth teeth include an axial tooth axially projecting toward the front cover plate and a radial tooth radially projecting toward the rotor.

7. The seal assembly of claim 6, wherein the axial tooth is positioned such that at least some of the fluid passes between the axial tooth and the front cover plate, and further flows through at least one cross-over port present in the front cover plate or at least one cross-over port present in the shoe plate.

8. The seal assembly of claim 1, wherein the shoe plate is positioned to be subjected to hydrodynamic or aerodynamic forces due to one or more of a presence of curvature mismatch, spiral grooves on the rotor, spiral grooves on the shoe plate, or Rayleigh steps on the shoe plate.

9. The seal assembly of claim 1, where the shoe plate is positioned to be subjected to a hydrostatic or aerostatic force due to a presence of high-pressure fluid jets emanating from internal cavities in the shoe plate and impinging on the rotor.

10. The seal assembly of claim 8, wherein the seal assembly is stationary and rides on the rotor during spinning of the rotor due to one or more hydrodynamic self-correcting forces or hydrostatic self-correcting forces.

11. The seal assembly of claim 1, wherein the shoe plates of the seal segments are separated from each other by a segment gap.

12. The seal assembly of claim 1, wherein the shoe plates of neighboring seal segments of the seal segments are interlocked with slanted faces to reduce segment leakage.

13. The seal assembly of claim 1, further comprising one or more flexural pivots that flex to allow for rolling and pitching motions of the shoe plate.

14. A method comprising:
forming one or more seal segments of a seal assembly for a rotary machine using additive manufacturing, wherein the one or more seal segments are shaped to be positioned circumferentially intermediate to a stationary housing and a rotor of the rotary machine,
wherein forming the one or more of the seal segments includes forming a stator interface element, a radially oriented front cover plate, and a shoe plate using additive manufacturing,
wherein the shoe plate is formed using additive manufacturing to include one or more labyrinth teeth forming a primary seal with the rotor, a load bearing surface radially offset from the one or more labyrinth teeth, a radial surface forming a frictionless secondary seal with the front cover plate, and one or more internal passageways configured to direct fluid from outside of the shoe plate, through the shoe plate, and between the radial surface of the shoe plate and the front cover plate to form the frictionless secondary seal.

15. The method of claim 14, wherein the one or more seal segments are formed using additive manufacturing such that the frictionless secondary seal formed by the radial surface and the one or more internal passageways of the shoe plate or the one or more internal passageways of the front plate is self-correcting based on a magnitude of film pressure applied to a radial surface of the shoe plate and an axial support force applied to the shoe plate.

16. The method of claim 15, wherein the one or more seal segments are formed using additive manufacturing such that the frictionless secondary seal is self-correcting in that, as an axial dimension of a gap between the radial surface of the shoe plate and the cover plate increases, a support force applied to the shoe plate along an axial direction and a fluid pressure applied by the frictionless secondary seal between the front cover plate and the shoe plate changes in magnitude to restore the axial dimension by decreasing the gap to a previous equilibrium position and, as the axial dimension of the gap between the radial surface of the shoe plate and the cover plate decreases, the support force applied to the shoe plate along the axial direction and the fluid pressure applied by the frictionless secondary seal between the front cover plate and the shoe plate change in magnitude to restore the axial dimension by increasing the gap to the previous equilibrium position..

17. The method of claim 14, wherein the one or more seal segments are formed using additive manufacturing such that the one or more seal segments also includes one or more flexible elements disposed between the shoe plate and the stator interface element, and such that the one or more flexible elements are configured for aiding a radial movement of the shoe plate relative to the stator interface element and configured for providing axial spring support for the shoe plate.

18. An assembly comprising:
plural seal segments shaped to be disposed circumferentially between a stator and a rotor of a rotary machine, wherein at least one of the seal segments includes:
a stator interface plate positioned to face the stator;
a front cover plate in contact with the stator interface plate and positioned to radially extend between the stator and the rotor; and
a shoe plate having a radial face that opposes the front cover plate and a bearing surface positioned to face the rotor, one or more of the shoe plate or the front plate having one or more internal passages shaped to direct fluid from outside of the at least one seal segment to a gap in a seal between the radial face of the shoe plate and the front cover plate,
wherein the one or more internal passages are shaped to direct the fluid to the gap to reduce or eliminate friction between the radial face of the shoe plate and the front cover plate.

19. The assembly of claim 18, wherein the shoe plate also includes an axially oriented tooth that forms the seal between the radial face of the shoe plate and the front cover plate by projecting toward the front cover plate.

20. The assembly of claim 18, wherein the seal formed by the radial surface and the one or more internal passageways of the shoe plate is self-correcting based on a magnitude of axial force applied to the front cover plate.

21. The seal assembly of claim 18, wherein the gap in the seal between the radial face of the shoe plate and the front cover plate changes size responsive to changes in pressure in the fluid.
